(19) United States
(12) Patent Application Publication
(10) Pub. No.: US 2026/0079728 A1
(43) Pub. Date: Mar. 19, 2026

(54) DYNAMIC FEED FOR AN INTERACTIVE AGENT

(71) Applicant: Salesforce, Inc., San Francisco, CA (US)

(72) Inventors: Alan WEIBEL, Reno, NV (US); Tommy DALE, San Diego, CA (US); Yon Aran RHEE, Dunedin (NZ); Clifford Andrew SEAL, Atlanta, GA (US); Cong NIU, San Mateo, CA (US); Divya HARIHARAN, Seattle, WA (US)

(73) Assignee: Salesforce, Inc., San Francisco, CA (US)

(21) Appl. No.: 19/030,275

(22) Filed: Jan. 17, 2025

Related U.S. Application Data
(60) Provisional application No. 63/695,174, filed on Sep. 16, 2024.

(51) Int. Cl. G06F 9/451; H04L 67/306

(52) U.S. Cl. CPC G06F 9/451; H04L 67/306

(57) ABSTRACT

An interactive agent may utilize a dynamic feed of a user interface to output an indication of a first data object in a first format based on a natural language request from a user device for the first data object. Based on an indication that the request for the first data object is associated with a user profile and an interaction with the indication of the first data object, modification data that indicates a modification for the first format may be mapped to the user profile. The interactive agent may modify a second format for an indication of a second data object to match the modification of the first format for the first data object based on the modification data and a natural language request for the second data object. The dynamic feed may output an indication of the second data object in the modified second format.

### CROSS-REFERENCE TO RELATED APPLICATION

This application claims the benefit of U.S. Provisional Application No. 63/695,174, filed Sep. 16, 2024, which is incorporated herein by reference in its entirety.

### BACKGROUND

The advancement of artificial intelligence (AI) and machine learning technologies has enabled the development of intelligent systems capable of understanding and responding to various requests, queries, and/or searches related to different systems and services. Traditional systems, such as customer relationship management (CRM) systems and the like, require users to interact with CRM tools and resources through structured interfaces with static feed patterns (e.g., how data from different sources-such as CRM databases, external APIs, user interactions, etc.). Interacting with CRM tools and resources via structured interfaces and static feed patterns can be inefficient, cumbersome, and error-prone. Users are unable to interact with CRM tools and resources naturally, using conversational language, while also ensuring data security and accuracy.

### BRIEF DESCRIPTION OF THE DRAWINGS/FIGURES

The accompanying drawings, which are incorporated herein and form a part of the specification, illustrate embodiments of the present disclosure and, together with the description, further serve to explain the principles of the disclosure and to enable a person skilled in the arts to make and use the embodiments.

FIG. 1 is a block diagram of a system for an interactive agent to manipulate a dynamic feed, according to some embodiments.

FIG. 2 illustrates a flowchart of an example process for an interactive agent to manipulate a dynamic feed, according to some embodiments.

FIG. 3 illustrates a flowchart of an example process for an interactive agent to manipulate a dynamic feed, according to some embodiments.

FIG. 4 illustrates a computer system, according to exemplary embodiments of the present disclosure.

The present disclosure will be described with reference to the accompanying drawings. In the drawings, like reference numbers indicate identical or functionally similar elements. Additionally, the left-most digit of a reference number identifies the drawing in which the reference number first appears.

### DETAILED DESCRIPTION OF THE INVENTION

Provided herein are system, apparatus, device, method, and/or computer program product embodiments, and/or combinations and sub-combinations thereof, for an interactive agent to manipulate a dynamic feed.

The technical landscape and/or infrastructure of a business and/or operating entity, such as a customer relationship management (CRM) platform, integration platform, and/or the like, may incorporate a wide array of applications, services, data sources, servers, resources, and/or the like. The technical landscape and/or infrastructure may be designed to help businesses/entities manage interactions with current and potential customers. The technical landscape and/or infrastructure may centralize customer data, streamline communication, and automate various business processes to improve customer relationships, sales, and overall business efficiency.

A CRM platform, integration platform, system of record, structured and unstructured data management platform, and/or the like may allow users to create and use various business processes, applications, and other software tools that leverage and incorporate data from disparate systems, services, applications, and third-party systems. A CRM platform, integration platform, and/or the like may store detailed information about customers, including contact details, communication history, purchase records, preferences, and more. Different users associated with the CRM platform, integration platform, and/or the like may use an interactive agent (e.g., a chatbot, an artificially intelligent assistant, a digital assistant, etc.) to access, review, analyze, and/or manipulate target data (e.g., a data object, a data entity, etc.).

A dynamic feed pattern for an interactive agent refers to how the interactive agent dynamically updates and personalizes the information it provides or displays to a user based on their interactions, preferences, and data it gathers. As described herein an interactive agent may utilize a dynamic feed of a user interface to output an indication of a first data object (or data entity, etc.) in a first format based on a request from a user device for the first data object. For example, based on an interaction with the indication of the first data object, modification data that indicates a modification for the first format may be generated. The interactive agent may modify a second format for an indication of a second data object (or data entity, etc.) to match the modification of the first format for the first data object based on the modification data and a request from the user device for the second data object. The interactive agent may output an indication of the second data object in the modified second format.

As described herein, the interactive agent may adapt the information displayed and/or provided to a user based on user behavior, preferences, and real-time data changes. A dynamic feed for the interactive agent may be used to provide users with personalized, context-aware content that updates in real-time, thus improving the efficiency and accuracy of operations performed by a business and/or operating entity. The feed can include various types of content, such as text, images, videos, interactive elements (e.g., graphs, charts, analytic outputs, etc.), and/or the like dynamically adapted to a user's preferences, interaction history, and/or the like. These and other advantages are described in detail herein.

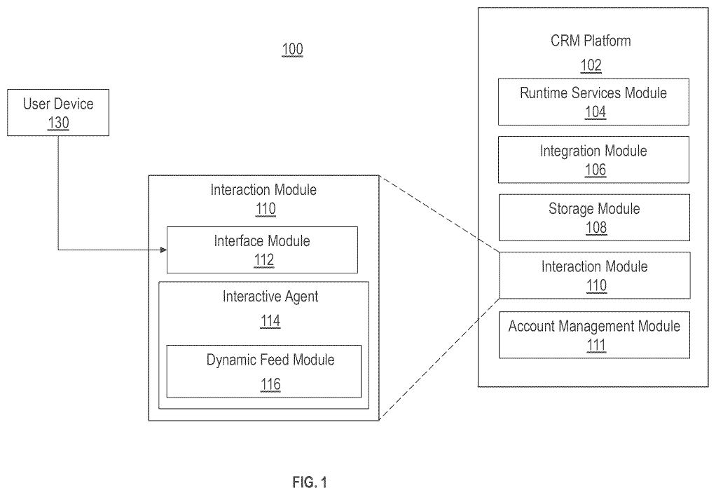

FIG. 1 shows a block diagram of an example system 100 supporting a dynamic feed for an interactive agent. System 100 may include a customer relationship management (CRM) platform 102 and user device(s) 120.

CRM platform 102 may be and/or include a system and/or software platform designed to help an entity manage interactions with users. CRM platform 102 may centralize user data, streamline communication, and automate various entity/business processes to improve customer relationships, sales, and overall operational efficiency. CRM platform 102 may include multiple integrated cloud-based services (e., As-a-service, etc.), applications, tools, and utilities that support customer data management, sales management, marketing automation, customer support/service, analytics, reporting, collaboration, and/or the like.

CRM platform 102 may enable disparate users/user device(s) 130, for example, users associated with a business marketing team/group, sales team/group, commerce team/group, service and IT teams/groups, and/or the like to work together and exchange data via a cloud-based architecture. For example, CRM platform 102 may facilitate and/or support customer relationship management applications, services, and/or the like. CRM platform 102 may be configured to design, maintain, and deploy integration flows based on disparate software applications, services, and/or data sources. For example, CRM platform 102 may include/incorporate an enterprise service bus (ESB) architecture, a micro-service architecture, a service-oriented architecture (SOA), and/or the like. According to some embodiments, CRM platform 102 may allow a user to build and deploy integrations that communicate with and/or connect to third-party systems and provide additional functionalities that may be used to further integrate data from a plurality of organizational and/or cloud-based data sources. CRM platform 102 may allow users to access data, manipulate data, store data, and leverage data from disparate resources.

According to some aspects, CRM platform 102 may include a runtime services module 104, integration module 106, a storage module 108, and an interaction module 110.

Runtime services module 104 may include runtime components for building, assembling, compiling, and/or creating executable object code for specific platform integration scenarios at runtime. According to some embodiments, runtime components may create interpreted code to be parsed and applied upon execution. In some embodiments, runtime components may include a variety of intermediary hardware and/or software that runs and processes the output of work/integration flows, such as a feed pattern for an interactive agent. The runtime services module 104 may provide a point of contact between components of system 100. The runtime services module 104 may also include various system APIs.

Integration module 106 may provide connections between CRM platform 102 and external resources, such as databases, APIs for software as a service (SaaS) applications (and/or the like), and many other endpoints. Integration module 106 may include pre-built connectors to various data sources, enabling seamless integration with CRM records, external APIs, and third-party data providers. Integration module 106 may include APIs that are pre-built and selectable within an interface module 112, for example, using a drag-and-drop interface. Integration module 106 may provide reliable connectivity solutions to connect to a wide range of applications integrating with any other type of asset (e.g., Salesforce, Amazon S3, Mongo Db, Slack, JIRA, SAP, Workday, Kafka, etc.). The integration module 106 may enable connection to any type of API, for example, communication APIs, SOAP APIs, REST APIs, Bulk APIs, Streaming APIs, and/or the like. Integration module 106 may facilitate the transfer of data from a source and a target by modeling the data into a file and/or the like, such as separated value files (CSV*, TSV, etc.), JavaScript Object Notation (JSON) text files delimited by new lines, JSON Arrays, and/or any other type of file.

Integration module 106 may be responsible for and/or facilitate connecting to one or more devices, applications, services, and/or the like implemented and/or support by CRM platform 102. Integration module 106 may be responsible for and/or facilitate authenticating and/or performing operations to exchange data, for example, such as data associated with cloud-based products and services. Integration module 106 may be responsible for and/or facilitate OAuth (e.g., used to establish user identity, used to approve a customer/client application access to protected resources, etc.), non-Blocking operations, stateless connection, low-level error handling, and reconnection. Integration module 106 may collect and integrate data from various sources, including CRM records, third-party APIs, and user interaction logs. Integration module 106 may may execute algorithms to normalize and structure data communicated within CRM platform 102 for processing.

Storage module 108 may store data relating to CRM platform 102. For example, storage module 108 may store all the data used by CRM platform 102, such as data including, but not limited to, data objects, user records, interaction logs, user account information, and/or the like.

According to some aspects, interaction module 110 may provide and/or manage user interface components corresponding to data associated with CRM platform 102. Interaction module 110 may standardize access to various data sources, provide a communication medium between third-party systems and data, and provide additional functionalities that further integrate data from a plurality of cloud-based sources. Interaction module 110 may include a store of internal mappings that determine user interface components that may be rendered and/or displayed by a user device(s) 120 based on data/information from CRM platform 102. Interaction module 110 may interact with CRM platform 102 to manage, request, and/or enable the viewing of data.

Interaction module 110 support, and/or be configured with an interface module 112. Interface module 112 may include, support, etc. any type of user interface(s) including, but not limited to, a graphical user interface (GUI), a command line interface (CLI), a menu-driven user interface (UI), a touch UI, a form-based UI, and/or the like. Data at CRM platform 102 may have various types. In order to efficiently view and interact with the data, interaction module 110 may store (or access via storage module 108) components mapped to data types. Interaction module 110 may indicate to a user device(s) 120 which component for interface module 112 to render and/or display based on a data type. Data types may include, but are not limited to, primitive types (e.g., integers, floats, strings, booleans, etc.), composite types (e.g., arrays, lists, maps, objects, etc.), enumerations (e.g., days of a week, a series of years, etc.), temporal data types (e.g., date, time, timestamps, etc.), linked structures (e.g., linked list, graphs, trees, hierarchal arrangements, etc.).

According to some aspects, interaction module 110 may include an interactive agent 114 (e.g., a chatbot, an artificial intelligence assistant, etc.) that facilitates access, display, review, interaction, and/or the like of data and/or information communicated within CRM platform 102. According to some aspects of this disclosure, the interactive agent 120 may access available APIs and other communication protocols s to automatically leverage available resources, data/information, and/or functionalities in the CRM platform 102. The interactive agent 114 may be supported by deep learning models of interaction module 110 including, but not limited to, recurrent neural networks (RNNs), transformers, and/or the like that are trained on vast datasets to understand context, intent, and content relevance.

Interactive agent 114 may support advanced AI capabilities to support natural language conversations with users of the user device(s) 120 to provide a personalized experience for the user. Interactive agent 114 may embed advanced machine learning and/or artificial intelligence (AI) capabilities in data of CRM platform 102—in fields, objects, workflows, components, and/or the like. Interactive agent 114 may leverage any/all the data of CRM platform 102 including, but not limited to, interactions with interactive agent 114, interactions with data objects, activity data from chat and communication applications, emails, calendar information, e-commerce data, image/video data, audio data, IoT signals—to train predictive models to provide customized responses to queries, request, and/or the like. The predictive models may enable interactive agent 114 to provide relevant content in response to queries. The predictive models may enable interactive agent 114 to proactively generate information relevant to a user before the user asks or submits a request. For example, in a scenario where a interactive agent 114 supports a sales/product team or organization, interactive agent 114 may provide indication of a potential issue with a customer order based data elements (e.g., inventory, consumer regulations, supporting resources, etc.) associated with the order. In another scenario, interactive agent may identify that a user belongs to a particular group or organization and can proactively generate information related to a scheduled meeting, quarterly sales targets, or any other context specific information. The predictive models may learn, self-tune and optimize with every interaction with data/data objects of CRM platform 102 and any additional data/information. Interactive agent 114 can automatically discover and/or predict the best responses to user messages, queries, requests, and/or the like submitted via a dynamic feed.

According to some aspects of this disclosure, interactive agent 114 may be used to perform tasks and update data associated with CRM platform 102. For example, a user of user device 120 may launch (e.g., via a supported application, etc.), receive, access (e.g., via a webpage, etc.), and/or the like a user interface supported by, facilitated by, and/or associated with interface module 112 to utilize interactive agent 114. Interactive agent 114 may operate as a dynamic tool/agent for data/information retrieval, access, presentation, manipulation, and/or the like. Interactive agent 114 may be supported by one or more deep learning models, such as recurrent neural networks (RNNs) and transformers, that are trained on vast datasets to understand context, intent, and content relevance.

According to some aspects of this disclosure, interactive agent 114 may retrieve data from CRM platform 102 (e.g., storage module 108, etc.), including, but not limited to, CRM records, customer interaction histories, sales opportunities, support tickets, and/or the like. According to some aspects of this disclosure, interactive agent 114 may gather real-time data from external sources, such as news feeds, market data, social media platforms, etc.).

For example, a user of user device 120 may submit a query to interactive agent 114. Interactive agent 114 may retrieve an existing data record and/or data object from storage module 108 in response to the query and can communicate the data record and/or data object back to user device 120. Interactive agent 114 may output the data object. For example, interactive agent 114 can present, provide, and/or display the retrieved data record and/or data object to user device 120. According to some aspects of this disclosure, interactive agent 114 may use the data record and/or data object to generate a natural language response that is sent to user device 120. Interactive agent 114 may present data to a user of user device 120 via interface module 112 and a dynamic feed supported by dynamic feed module 116. The dynamic feed may be an interactive data exchange medium and/or data stream of a user interface of interface module 112 that interactive agent 114 uses to provide dynamic and updated information to users. The dynamic feed can be integrated into the functionalities of interactive agent 114 to enhance its interaction capabilities, which include, but are not limited to, providing a medium for interactive agent 114 to provide, output, present, and/or deliver relevant, timely, and contextually appropriate responses to multimodal input based on the most current data available within CRM platform 102.

According to some aspects of this disclosure, interactive agent 114 may use natural language processing techniques to interpret user queries and generate context-aware responses. Interactive agent 114 may support various languages and dialects, with the ability to learn and adapt to user-specific terminology over time. According to some aspects of this disclosure, to provide, output, present, and/or deliver relevant, timely, and contextually appropriate responses to multimodal input, interactive agent 114 may include and/or communicate with a large language model(s) (LLM). The LLM may serve as a knowledge base trained on a large corpus of relative data (e.g., CRM data, etc.). The LLM may enable interactive agent 114 to take in natural language input and output natural language responses. It supports various languages and dialects, with the ability to learn and adapt to user-specific terminology over time.

According to some aspects of this disclosure, an LLM(s) included with and/or in communication with interactive agent 114 may be constructed from multiple neural network layers including, but not limited to, recurrent layers, feedforward layers, embedding layers, attention layers, and/or the like that operate in tandem to process input data (e.g., text, video/image data, metadata, structured data, etc.) and generate an output. An embedding layer of an LLM may generate embeddings from the input data. For example, the embedding layer may be configured to capture the semantic and syntactic meaning of any input text to enable the LLM to understand the context. The feedforward layer may include multiple fully connected layers that transform the input embeddings. Feedforward layers enable the LLM to glean higher-level abstractions (e.g., user intent, etc.) from the input text. The recurrent layer may interpret the words in the input text in sequence to understand their relationship, and the attention layers may use weights that enable the LLM to focus on single parts of the input text that are relevant to the task at hand.

An LLM included with and/or in communication with interactive agent 114 may be trained on large textual datasets consisting of trillions of words, trillions of images, and/or the like fed to the LLM in an unsupervised manner. During this training, a semantic analysis algorithm may be used to enable the LLM to learn word meanings, relationships between words, word context distinctions, etc. An object recognition algorithm may be used to enable the LLM to learn object types, visual descriptions, visual cues, etc. A trained LLM may be fine-tuned for a specific task such as outputting responses based on relative prompts. For example, the LLM may be used to provide a response to textual prompts, visual prompts, audio prompts, and/or the like from interactive agent 114 that are output by a dynamic feed.

According to some aspects of this disclosure, interaction between interactive agent 114 and dynamic feed module 116, such as how data is received, ingested, output, presented, displayed, and/or the like may be modified according to modification information indicated by a user profile (e.g., user identity, users preferences, user privileges/permissions, etc.) and/or on contextual factors (e.g., device (or GPS) location, device type, current or historical user behavior, user interactions, calendar events, time-sensitive tasks, etc.).

According to some aspects of this disclosure, interactions with interactive agent 114 may be tracked by dynamic feed module 116 to build a user profile. For example, interaction module 110 may collect detailed interaction data as a user of user device 120 engages with a data record (e.g., available via storage module 108, etc.). Interaction data may include, but is not limited to, tracking mouse movements, clicks, scroll depth, time spent on specific sections of the data, any engagement metrics, and/or the like. The interaction data may be stored with and/or associated with a user profile.

A user profile may be analyzed to identify patterns, preferences, and/or the like for engaging with data objects. For example, interaction data may indicate pattern information such as: whether a user request more detailed information or summaries related to a data object; whether a user engages positively (e.g., through likes, positive feedback, etc.) or negatively (e.g., ignoring or quickly dismissing the content associated with a data object, etc.); whether a user resizes a chart associated with a data object; whether a user reshuffles, rearranges, or otherwise manipulates data elements associated with a data object; etc. Interaction data may be analyzed to indicate the context of interactions with data objects. For example, if the data object is a deal/sales report, analysis of interaction data may be used to determine if the user prefers in-depth analysis or just a headline overview. Any information may be gleaned from interaction data and used to update a user profile accordingly.

When a user of user device 120 accesses interactive agent 114 via a dynamic feed, dynamic feed module 116 may process aggregated user interaction data from a user profile using one or more machine learning models trained on historical interaction data to predict user interaction behavior with data objects. For example, in a scenario where a user engages with a detailed financial report (first data record) and spends significant time on the analysis section but skips over basic definitions, a user profile may indicate that the user prioritizes detailed analytical content and deprioritizes basic definitions. When the user requests interactive agent 114 to provide another financial report (second data record), dynamic feed module 116 When presenting a second financial report (second data record), interactive agent 114 may use dynamic feed module 116 to present, display, and/or provide a more analytical summary of the financial report upfront and place definitions or basic concepts in collapsible sections, assuming the user prefers to focus on advanced content.

As described herein, each user may receive a customized experience of how data is presented, displayed, and/or provided via a dynamic feed based on their unique user profile. Based on the user profile, interactive agent 114 operates with dynamic feed module 116 to customize the presentation of requested data objects. This customization may include, but is not limited to, altering content format (e.g., providing a summary instead of the full text, showing a pie chart instead of a bar graph, etc.), adjusting the depth of information (e.g., highlighting key points for a user who prefers brevity, etc.), selecting appropriate media types (e.g., preferring infographics for a user who favors visual content, etc.).

According to some aspects of this disclosure, interaction module 110 may also identify contextual data such as the user's device type, time of access of the data record, and environmental factors (e.g., location, time of day), and may adjust how a data record is presented via a dynamic feed accordingly. For example, if interactive agent 114 identified that a request for a data object is from a user using a mobile device, a size, orientation, color, and/or other visual elements may be optimized for display on a mobile device. In another scenario, if interactive agent 114 identified that a request for a data object is from a user device 120 located in a particular country, information presented, displayed, and/or provided via a dynamic feed may be translated to a language spoken in the location where the user device is identified. According to some aspects of this disclosure, interactive agent 114 may operate with dynamic feed module 116 to provide any customization to the output of requested data objects based on interaction data indicated by a user profile. Interactive agent 114 may continuously learn from each interaction, updating a user profile as new data is presented and user behaviors evolve.

According to some aspects of this disclosure, the manner in which data is presented, displayed, and/or provided via a dynamic feed may be varied according to privileges and/or authorizations associated with a user profile. For example, interactive agent 114 may modify the information it provides and how it is presented via a dynamic feed by filtering content, customizing the format and layout, adapting visual elements, and adjusting its responses according to privileges and/or authorizations associated with a user profile.

CRM platform 102 may include an account management module 111. Account management module 111 may store a user account that includes privileges, authorizations, credentials, and/or the like that are associated with a user and/or user profile. According to some aspects of this disclosure, when interactive agent 114 receives a request from a user (e.g., a request for a data object, etc.), interactive agent 114 may authenticate the user and retrieve user account, which contains details about their access levels, privileges, authorizations, credentials, and/or the like. Depending on these privileges, interactive agent 114 may dynamically filter requested content, displaying or hiding specific data points and features according to what the user is authorized to see. Additionally, interactive agent 114 may customize the format and arrangement of the data based on a user account. For example, if a user is associated with a specific access level, have certain privileges enabled, has not received authorization, lacks required credentials, and/or the like, interactive agent 114 may enable access and/or viewing (via a dynamic feed) of simplified charts related to a data object, while a different user with certain privileges enabled, that has received authorization, that has required credentials, and/or the like could access detailed reports and interactive dashboards related to a data object.

According to some aspects of this disclosure, interactive agent 114 may also modify the visual presentation of a data object and/or the like, including color schemes and layout, based on a user account. For example, user accounts associated with higher-privilege users may enable interactive agent 114 to access additional tools or administrative controls. According to some aspects of this disclosure, responses to requests for data objects by interactive agent 114 may be adapted to a user's authorization level. For example, interactive agent 114 may provide high-level summaries for certain users (e.g., executives, administrative users, etc.) and detailed instructions for others (e.g., operational staff, contractors, etc.). According to some aspects of this disclosure, interactive agent 114 may maintain security data security through measures like data masking for sensitive information, ensuring that only authorized users can access it. According to some aspects of this disclosure, interactive agent 114 may personalize a dynamic feed based on user feedback and behavior, continuously refining the display, detail, orientation, and/or the like of information provided via a dynamic feed to match specific needs and roles of a user.

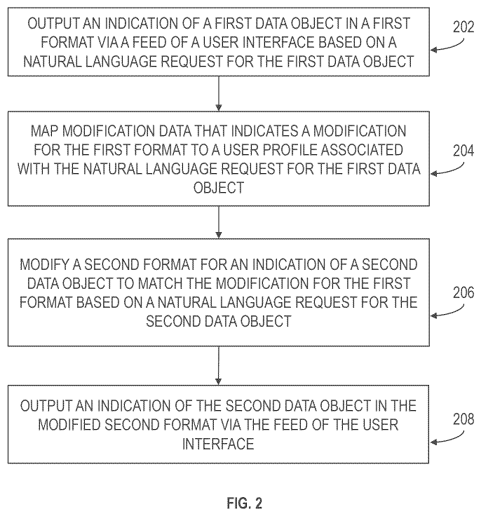

FIG. 2 shows a flowchart of an example method 200 for an interactive agent to manipulate a dynamic feed. Method 200 may be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 2, as will be understood by a person of ordinary skill in the art(s).

In 202, interactive agent 112 causes a feed of a user interface to output an indication of a first data object in a first format. Interactive agent 112 may cause the feed of the user interface to output the indication of a first data object in a first format based on a natural language request from a user device for the first data object. The first data object may include, but is not limited to, any data accessible via a platform, such as a CRM platform and/or the like.

According to some aspects of this disclosure, natural language request from the user device for the first data object may include, but is not limited to, a audio and/or audible transmission of the natural language request for the first data object, a typed and/or textual natural language request for the first data object, a translated natural language request for the first data object, and/or the like.

According to some aspects of this disclosure, the request from the user device for the first data object may include and/or be a request type different from a natural language request. For example, the request from the user device for the first data object may be any type of request for the first data object.

According to some aspects of this disclosure, the first format may include, but is not limited to, a natural language description of the first data object, a visual summary (e.g., a chart, a graph, an infographic, a timeline, etc.) of the first data object, an interactive element (e.g., an interactive dashboard statically and/or dynamically determined interactive elements, a map with clickable regions/markers, interactive sliders/filters, etc.) depicting the first data object, a multimedia representation (e.g., audio, video, animations, etc.) of the first data object, and/or the like.

In 204, interactive agent 112 maps modification data to a user profile. Interactive agent 112 may map the modification data to the user profile based on an indication that the request for the first data object is associated with a user profile (e.g., a user profile for a user of the user device) and an interaction with the indication of the first data object. The user profile may include historical data that indicates previous interactions with interactive agent 112 and/or data objects, previously requested/accessed data objects, user-specific behavioral data, and/or the like. The modification data may indicate a modification for the first format caused by the interaction with the indication of the first data object.

According to some aspects of this disclosure, the interaction with the indication of the first data object may include, but is not limited to: a selection of the indication of the first data object, playback of the indication of the first data object, a change in language when the first format is a natural language indication of the first data object, a resizing of the indication of the first data object, access of one or more elements of the indication of the first data object, a change to a visual representation of indication of the first data object, and/or the like. According to some aspects of this disclosure, the interaction with the indication of the first data object may include any type of interaction with the first data object.

In 206, interactive agent 112 modifies a second format for an indication of a second data object to match the modification for the first format.

Interactive agent 112 may modify the second format for the indication of the second data object to match the modification for the first format based on an indication that a natural language request received for a second data object is associated with the user profile and the modification data (e.g., may be modified as required by the modification data, etc.). A type of the first data object may correspond to a type of the second data object or at least a portion of the first data object may match the second data object. For example, the first data object may be customer/user account information and the second data object may be similar account information for a different customer/user, or the first and second data objects may be similar sales reports. The first data object and the second data object may share any type of relationship.

According to some aspects of this disclosure, interactive agent 112 may identifying a contextual factor associated with the request for the second data object. The contextual factor may include, but is not limited to, a device type of the user device, a time when the request for the second data object is received, a location of the user device, credential information associated with a user of the user device, and/or the like. Thus, according to some aspects of this disclosure, interactive agent 112 modifying the second format for the indication of the second data object to match the modification for the first format for the indication of the first data object may further include interactive agent 112 modifying, based on the contextual factor, the second format for the indication of the second data object to at least one of obscure a portion of second data object, add additional data to the second data object, or a recommendation for another data object associated with the second data object.

In 208, interactive agent 112 causes the feed of the user interface to output an indication of the second data object in the modified second format.

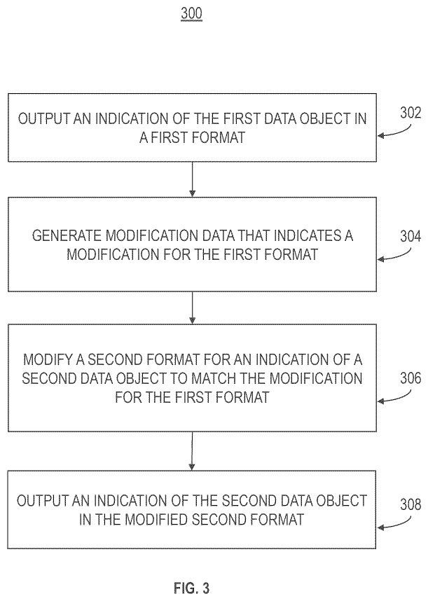

FIG. 3 shows a flowchart of an example method 300 for an interactive agent to manipulate a dynamic feed. Method 300 may be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art(s).

In 302, interactive agent 112 outputs an indication of a first data object in a first format. Interactive agent 112 may output the indication of the first data object in the first format based on a request from a user device for the first data object. The first data object may include, but is not limited to, any data accessible via a platform, such as a CRM platform and/or the like.

According to some aspects of this disclosure, the first format may include, but is not limited to, a natural language description of the first data object, a visual summary (e.g., a chart, a graph, an infographic, a timeline, etc.) of the first data object, an interactive element (e.g., an interactive dashboard statically and/or dynamically determined interactive elements, a map with clickable regions/markers, interactive sliders/filters, etc.) depicting the first data object, a multimedia representation (e.g., audio, video, animations, etc.) of the first data object, and/or the like.

In 304, interactive agent 112 generates modification data that indicates a modification for the first format caused by the interaction with the indication of the first data object. Interactive agent 112 may generate the modification data that indicates the modification for the first format based on an interaction with the indication of the first data object. For example, the interaction with the indication of the first data object may include, but is not limited to: a selection of the indication of the first data object, playback of the indication of the first data object, a change in language when the first format is a natural language indication of the first data object, a resizing of the indication of the first data object, access of one or more elements of the indication of the first data object, a change to a visual representation of indication of the first data object, and/or the like. According to some aspects of this disclosure, the interaction with the indication of the first data object may include any type of interaction with the first data object.

The modification data may be associated with and/or stored by a user profile for a user of the user device. The user profile may include historical data that indicates previous interactions with interactive agent 112 and/or data objects, previously requested/accessed data objects, user-specific behavioral data, and/or the like.

In 306, interactive agent 112 modifies a second format for an indication of a second data object to match the modification for the first format. Interactive agent 112 may modify the second format for the indication of the second data object to match the modification for the first format based on the modification data and a request from the user device for the second data object. A type of the first data object may correspond to a type of the second data object or at least a portion of the first data object may match the second data object. For example, the first data object may be customer/user account information and the second data object may be similar account information for a different customer/user, or the first and second data objects may be similar sales reports. The first data object and the second data object may share any type of relationship.

According to some aspects of this disclosure, interactive agent 112 may identifying a contextual factor associated with the request for the second data object. The contextual factor may include, but is not limited to, a device type of the user device, a time when the request for the second data object is received, a location of the user device, credential information associated with a user of the user device, and/or the like. Thus, according to some aspects of this disclosure, interactive agent 112 modifying the second format for the indication of the second data object to match the modification for the first format for the indication of the first data object may further include interactive agent 112 modifying, based on the contextual factor, the second format for the indication of the second data object to at least one of obscure a portion of second data object, add additional data to the second data object, or a recommendation for another data object associated with the second data object.

In 308, interactive agent 112 outputs an indication of the second data object in the modified second format. According to some aspects of this disclosure, interactive agent 112 outputs the indication of the second data object in the modified second format via a dynamic feed configured with a user interface of the user device.

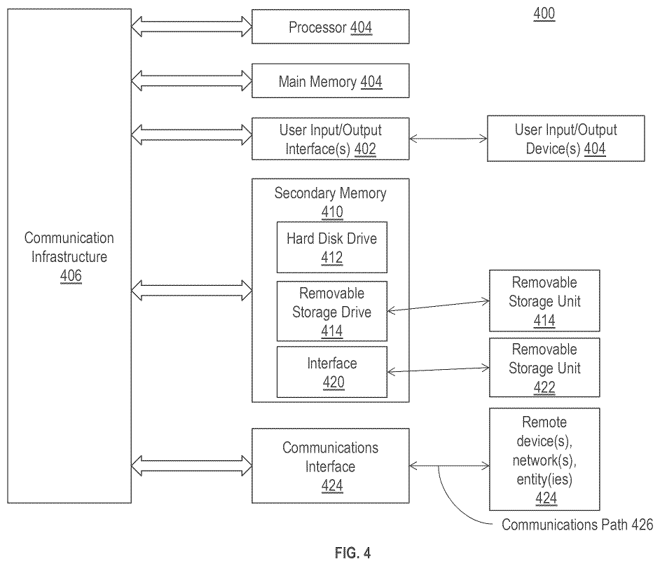

FIG. 4 is an example computer system useful for implementing various embodiments. Various embodiments may be implemented, for example, using one or more well-known computer systems, such as computer system 400 shown in FIG. 4. One or more computer systems 400 may be used, for example, to implement any of the embodiments discussed herein, as well as combinations and sub-combinations thereof.

Computer system 400 may include one or more processors (also called central processing units, or CPUs), such as a processor 404. Processor 404 may be connected to a communication infrastructure or bus 406.

Computer system 400 may also include user input/output device(s) 402, such as monitors, keyboards, pointing devices, etc., which may communicate with communication infrastructure or bus 406 through user input/output device(s) 402.

One or more of processors 404 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 may also include a main or primary memory 408, such as random access memory (RAM). Main memory 408 may include one or more levels of cache. Main memory 408 may have stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, a tape backup device, and/or any other storage device/drive.

Removable storage drive 414 may interact with a removable storage unit 418. The removable storage unit 418 may include a computer-usable or readable storage device having stored thereon computer software (control logic) and/or data. Removable storage unit 418 may be a floppy disk, magnetic tape, compact disk, DVD, optical storage disk, and/any other computer data storage device. Removable storage drive 414 may read from and/or write to the removable storage unit 418.

Secondary memory 410 may include other means, devices, components, instrumentalities, and/or other approaches for allowing computer programs and/or other instructions and/or data to be accessed by computer system 400. Such means, devices, components, instrumentalities, and/or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 may enable computer system 400 to communicate and interact with any combination of external devices, external networks, external entities, etc. (individually and collectively referenced by reference number 428). For example, communication interface 424 may allow computer system 400 to communicate with external or remote devices 428 over communications path 426, which may be wired and/or wireless (or a combination thereof), and which may include any combination of LANs, WANs, the Internet, etc. Control logic and/or data may be transmitted to and from computer system 400 via communication path 426.

Computer system 400 may also be any of a personal digital assistant (PDA), desktop workstation, laptop or notebook computer, netbook, tablet, smartphone, smartwatch or other wearables, appliance, part of the Internet-of-Things, and/or embedded system, to name a few non-limiting examples, or any combination thereof.

Computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats, and/or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), may cause such data processing devices to operate as described herein.

Based on the teachings contained in this disclosure, it will be apparent to persons skilled in the relevant art(s) how to make and use embodiments of this disclosure using data processing devices, computer systems, and/or computer architectures other than that shown in FIG. 4. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

Additionally and/or alternatively, while this disclosure describes exemplary embodiments for exemplary fields and applications, it should be understood that the disclosure is not limited thereto. Other embodiments and modifications thereto are possible and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

implementation One or more parts of the above implementations may include software. Software is a general term whose meaning of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method for an interactive agent to manipulate a dynamic feed comprising:
causing, based on a natural language request received by an interactive agent for a first data object, a feed of a user interface to output an indication of the first data object in a first format;
mapping, based on an indication that the natural language request for the first data object is associated with a user profile and an interaction with the indication of the first data object, modification data to the user profile, wherein the modification data indicates a modification for the first format caused by the interaction with the indication of the first data object;
modifying, based on an indication that a natural language request received by the interactive agent for a second data object is associated with the user profile and the modification data, a second format for an indication of a second data object to match the modification for the first format; and
causing the feed to output an indication of the second data object in the modified second format.

2. The method of claim 1, wherein the first format comprises a natural language description of the first data object.

3. The method of claim 1, wherein a type of the first data object corresponds to a type of the second data object, or at least a portion of the first data object matches the second data object.

4. The method of claim 1, wherein the interaction with the indication of the first data object comprises at least one of: a selection of the indication of the first data object, playback of the indication of the first data object, a change in language when the first format is a natural language indication of the first data object, a resizing of the indication of the first data object, access of one or more elements of the indication of the first data object, or a change to a visual representation of the indication of the first data object.

5. The method of claim 1, further comprising identifying a contextual factor associated with the natural language request for the second data object, wherein the modifying the second format for the indication of the second data object to match the modification for the first format for the indication of the first data object further comprises:
modifying, based on the contextual factor, the second format for the indication of the second data object to at least one of obscure a portion of second data object, add additional data to the second data object, or include a recommendation for another data object associated with the second data object.

6. The method of claim 5, wherein the contextual factor comprises at least one of a device type of a user device that sends the natural language request for the second data object, a time when the natural language request for the second data object is received, a location of the user device, or credential information associated with a user of the user device.

7. The method of claim 1, wherein the first format is different from the second format.

8. A system comprising:
a memory; and
at least one processor coupled to the memory and configured to perform operations for an interactive agent to manipulate a dynamic feed, the operations comprising:
causing, based on a natural language request received by an interactive agent for a first data object, a feed of a user interface to output an indication of the first data object in a first format;
mapping, based on an indication that the natural language request for the first data object is associated with a user profile and an interaction with the indication of the first data object, modification data to the user profile, wherein the modification data indicates a modification for the first format caused by the interaction with the indication of the first data object;
modifying, based on an indication that a natural language request received by the interactive agent for a second data object is associated with the user profile and the modification data, a second format for an indication of a second data object to match the modification for the first format; and
causing the feed to output an indication of the second data object in the modified second format.

9. The system of claim 8, wherein the first format comprises a natural language description of the first data object.

10. The system of claim 8, wherein a type of the first data object corresponds to a type of the second data object, or at least a portion of the first data object matches the second data object.

11. The system of claim 8, wherein the interaction with the indication of the first data object comprises at least one of: a selection of the indication of the first data object, playback of the indication of the first data object, a change in language when the first format is a natural language indication of the first data object, a resizing of the indication of the first data object, access of one or more elements of the indication of the first data object, or a change to a visual representation of the indication of the first data object.

12. The system of claim 8, the operations further comprising identifying a contextual factor associated with the natural language request for the second data object, wherein the modifying the second format for the indication of the second data object to match the modification for the first format for the indication of the first data object further comprises:
modifying, based on the contextual factor, the second format for the indication of the second data object to at least one of obscure a portion of second data object, add additional data to the second data object, or include a recommendation for another data object associated with the second data object.

13. The system of claim 12, wherein the contextual factor comprises at least one of a device type of a user device that sends the natural language request for the second data object, a time when the natural language request for the second data object is received, a location of the user device, or credential information associated with a user of the user device.

14. The system of claim 8, wherein the first format is different from the second format.

15. A non-transitory computer-readable medium having instructions stored thereon that, when executed by at least one computing device, causes the at least one computing device to perform operations for an interactive agent to manipulate a dynamic feed, the operations comprising:
causing, based on a natural language request received by an interactive agent for a first data object, a feed of a user interface to output an indication of the first data object in a first format;
mapping, based on an indication that the natural language request for the first data object is associated with a user profile and an interaction with the indication of the first data object, modification data to the user profile, wherein the modification data indicates a modification for the first format caused by the interaction with the indication of the first data object;
modifying, based on an indication that a natural language request received by the interactive agent for a second data object is associated with the user profile and the modification data, a second format for an indication of a second data object to match the modification for the first format; and
causing the feed to output an indication of the second data object in the modified second format.

16. The non-transitory computer-readable medium of claim 15, wherein the first format comprises a natural language description of the first data object.

17. The non-transitory computer-readable medium of claim 15, wherein a type of the first data object corresponds to a type of the second data object, or at least a portion of the first data object matches the second data object.

18. The non-transitory computer-readable medium of claim 15, wherein the interaction with the indication of the first data object comprises at least one of: a selection of the indication of the first data object, playback of the indication of the first data object, a change in language when the first format is a natural language indication of the first data object, a resizing of the indication of the first data object, access of one or more elements of the indication of the first data object, or a change to a visual representation of the indication of the first data object.

19. The non-transitory computer-readable medium of claim 15, further comprising identifying a contextual factor associated with the natural language request for the second data object, wherein the modifying the second format for the indication of the second data object to match the modification for the first format for the indication of the first data object further comprises:
modifying, based on the contextual factor, the second format for the indication of the second data object to at least one of obscure a portion of second data object, add additional data to the second data object, or include a recommendation for another data object associated with the second data object.

20. The non-transitory computer-readable medium of claim 19, wherein the contextual factor comprises at least one of a device type of a user device that sends the natural language request for the second data object, a time when the natural language request for the second data object is received, a location of the user device, or credential information associated with a user of the user device.
